(19) United States
(12) Patent Application Publication
(10) Pub. No.: US 2026/0184409 A1
(43) Pub. Date: Jul. 2, 2026

(54) ADAPTIVE TOOLING INTERFACE (TOOL CHANGER) WITH A SINGLE MOTOR

(71) Applicant: Oceaneering International, Inc., Houston, TX (US)

(72) Inventors: Charles B. Hansen, Bryne (NO); Torleif CARLSEN, SANDNES (NO)

(73) Assignee: Oceaneering International, Inc., Houston, TX (US)

(21) Appl. No.: 19/549,317

(22) Filed: Feb. 25, 2026

Related U.S. Application Data
(62) Division of application No. 18/371,875, filed on Sep. 22, 2023.
(60) Provisional application No. 63/409,121, filed on Sep. 22, 2022.

(51) Int. Cl. B63C 11/52; B23Q 3/155

(52) U.S. Cl. CPC B63C 11/52; B23Q 3/15553; B23Q 3/15503

(57) ABSTRACT

An adaptive tooling interface comprises a single motor, disposed at least partially within a housing, which is operatively in communication with a controller and where a first power output and a second power output are operatively in communication with the motor. A drive interface, comprising a external tool interface, is operatively in communication with the motor and configured to mate with and provide power to one or more external tools, which comprise a matching subsea external tool external tooling interface, via the first power output and the second power output. The adaptive tooling interface may be connected to or otherwise integrated into a subsea vehicle system comprising a subsea vehicle.

### RELATION TO OTHER APPLICATIONS

This application is a divisional application of U.S. application Ser. No. 18/371,875 filed on Sep. 22, 2023 and claims priority through U.S. Provisional Application 63/409,121 filed on Sep. 22, 2022.

### BACKGROUND

Underwater vehicles, such as remotely operated vehicles (ROV) or autonomous underwater vehicles (AUV), have the ability to operate external tooling to perform subsea intervention. One of the key underwater vehicle abilities will be to accommodate a versatile external tooling interface such as an ROV or AUV external tooling interface, in combination with a matching subsea external tool external tooling interface. These interfaces may be crucial to AUV/ROV performance and a new interface standard may be required ensure future adaptability of upcoming external tooling technology.

Further, conventional ROV external tools such as an ROV manipulator may not be an optimal external tool handling solution on a hydrodynamic vehicle such as a subsea drone. In such cases, a lightweight and versatile unit may be required to reduce the overall power consumption and to increase operational readiness, without compromising vehicle balance as well as reducing external tool interface complexity.

### FIGURES

Various figures are included herein which illustrate aspects of embodiments of the disclosed inventions.

FIGS. 1A and 1B are cutaway views in partial perspective and FIG. 1C is a block diagram of an exemplary single motor embodiment of the claimed invention

FIG. 2 is an exploded view in partial perspective of an exemplary embodiment of the claimed invention;

FIG. 3 is a cutaway view in partial perspective of an exemplary embodiment of a drive interface of the claimed invention;

FIGS. 4A and 4B are cutaway views in partial perspective of an exemplary embodiment of a drive interface of the claimed invention illustrating a latch;

FIG. 5 is a cutaway view in partial perspective of an exemplary embodiment of a drive interface of the claimed invention illustrating operation of a latch;

FIG. 6 is a cutaway view in partial perspective of an exemplary embodiment of the claimed invention;

FIG. 7 is a cutaway view in partial perspective of an exemplary embodiment of a drive interface and external tool interface of the claimed invention;

FIG. 8 are cutaway views in partial perspective of an exemplary embodiment of manipulator jaws of the claimed invention;

FIG. 9 is a block diagram illustrating various external tools to be interfaced with the drive interface of the claimed invention;

FIG. 10 is a view in partial perspective of an exemplary embodiment of the claimed invention attached to a external tool;

FIG. 11 is a view in partial perspective of an exemplary embodiment of the claimed invention detached from the external tool;

FIG. 12 is a block schematic diagram of an exemplary embodiment of a controller for the claimed invention;

FIGS. 13A and 13B are a block schematic diagram of an exemplary embodiment of a system incorporating the claimed invention;

FIG. 14 is a block schematic diagram of an exemplary embodiment of the system the claimed invention illustrating a cover;

FIG. 15 is a detail illustrating the cover opened and the exemplary adaptive external tool interface exposed to an externa environment and rotated;

FIG. 16 is a block schematic diagram of a further exemplary embodiment of the system the claimed invention illustrating a housed drone; and

FIG. 17 is a view in partial perspective of a drone.

### DESCRIPTION OF EXEMPLARY EMBODIMENTS

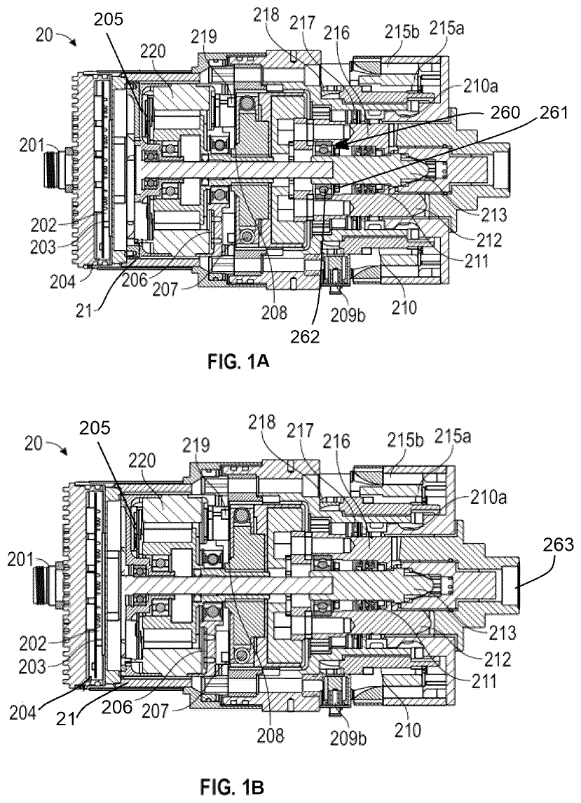

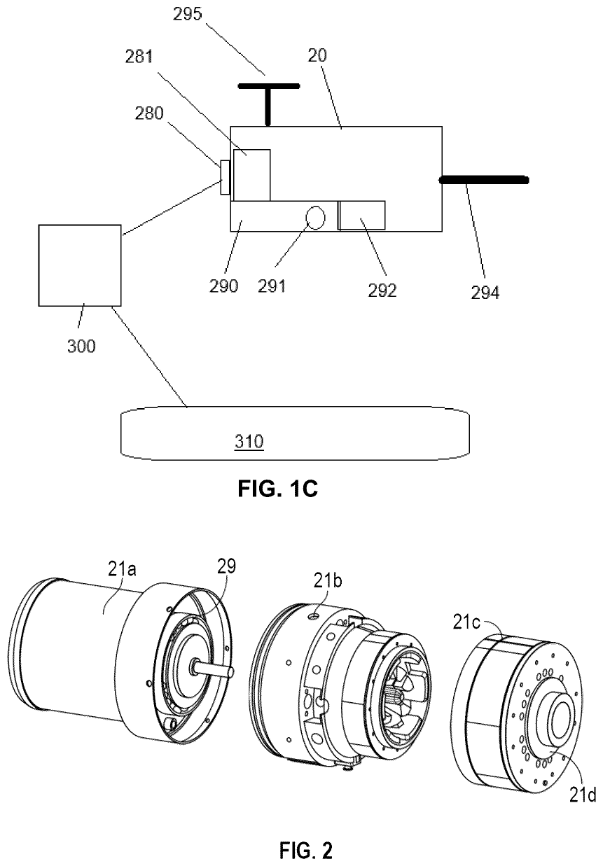

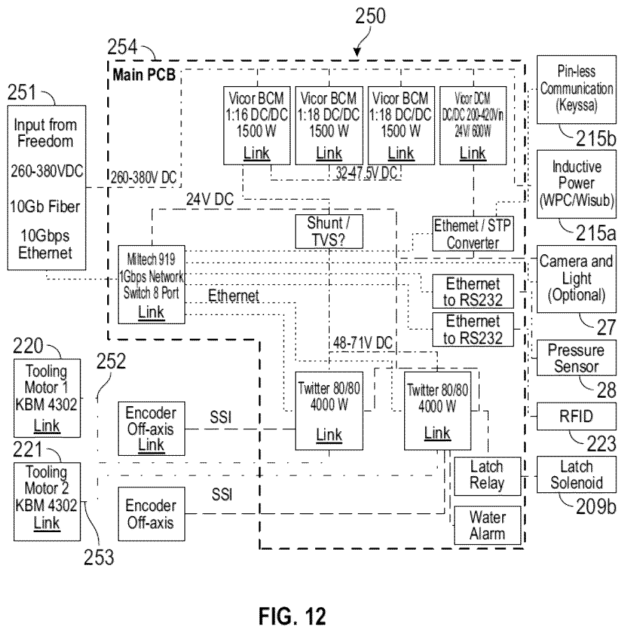

Referring to FIGS. 1A and 1B, in a first embodiment adaptive tooling changer 20 comprises single motor 220 with two outputs 212,213 and may be used along with switch 260, comprising a transmission such as gearbox 261 or clutch 262. Alternatively, referring to FIG. 1B, a single mechanical drive 220 and pinless power transfer 263 (similar to 215a in FIG. 12) may be used to enable two or more functions, especially as pinless power and/or data communications can be used to provide more than one function. In either single motor configuration, a predetermined set of power outputs are operatively in communication with switch 260 and configured to provide power from single motor 220, e.g., first power output 213 comprising a speed output and second power output 212 comprising a torque output.

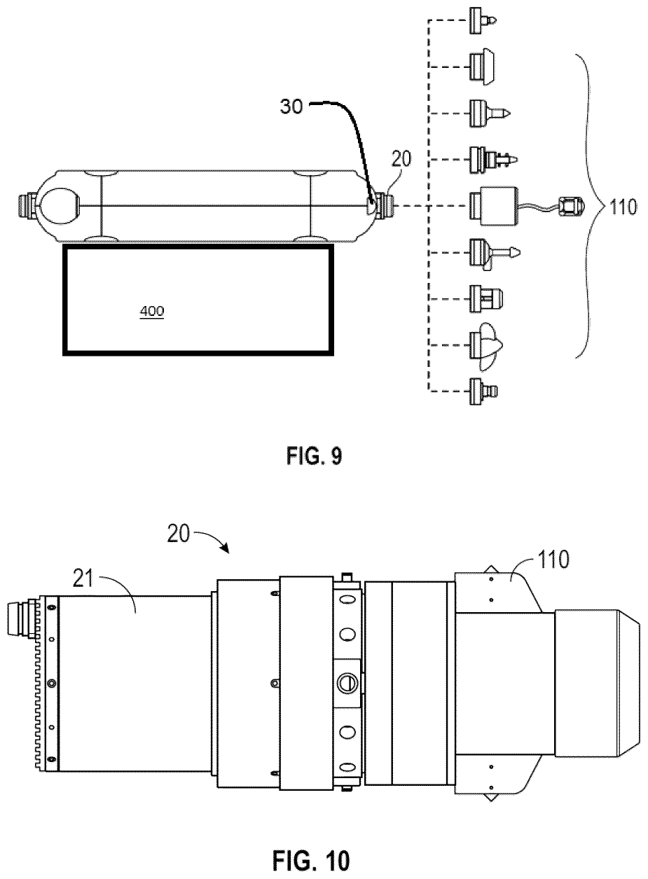

Adaptive tooling changer 20 typically comprises housing 21, single motor 220 disposed at least partially in housing 21, power connector 280 (FIG. 1C) operatively in communication with single motor 220, switch 260 operatively connected to single motor 220, first power output 213 operatively in communication with switch 260 and operative to provide power to first external tool 110 (FIG. 9) selected from a predetermined set of external tools 110, and second power output 212 operatively in communication with switch 260 and operative to provide power to second external tool 110 selected from the predetermined set of external tools 110.

Either of first power output 213 or second power output 212 may comprise a speed output and other a torque output. In embodiments, first power output 213 comprises a mechanical power output and second power output 212 comprises a power output, a data output, or power and data output. This can be the reverse as well. Typically as well, adaptive tooling changer 20 provides one or more external tools 110 (FIG. 9) selected from a predetermined set of external tools 100 with simultaneous power and data communication thru pin-less induction. Adaptive tooling changer 20, which may be semi-resident, i.e., temporary connected and not fixed to a subsea asset, may receive power from subsea asset 400 (FIG. 9). Adaptive tooling changer 20 may also comprise a back electric/magnetic EMF circuit, which is a part of internal electronics of adaptive tool changer 20 and adapted to mitigate energy generated by external tool inertia and store and/or burn power transferred back to adaptive tooling changer 20, e.g., to avoid destruction.

Typically, a primary mode of power transfer from single motor 220 to external tool 110 selected from the predetermined set of external tools 110 comprises a mechanical power transfer.

Switch 260 may comprise a gearbox or a clutch. If switch 260 comprises a gearbox, adaptive tooling changer 20 may further comprise a geared external tool interface to interface with external tool 110 selected from the predetermined set of external tools 110.

In another embodiment, adaptive tooling changer 20 comprises a direct drive external tool interface without gears disposed inline to interface with the external tool 110 selected from the predetermined set of external tools 110.

Generally, single motor 220 comprises a brushless, gearless interface through which it is connected to the external tool interface 21d (FIG. 2) and a brushless, gearless motor.

Power connector 280 is typically configured to interface to an external power source such as a power source from a subsea vehicle (e.g., a remotely operated vehicle (ROV) or an autonomous underwater vehicle (AUV)), a cage power source, or a subsea asset power source, or the like.

Referring additionally to FIG. 1C, power supply 300 may be present and operatively connected to single motor 220. Power supply 300 may comprise an internal power source such as a battery or a fuel cell operatively in communication with power connector 280. In addition, integrated communicator 290, which may comprise data communication inductive ring 291, may be present and operatively connected to power supply 220.

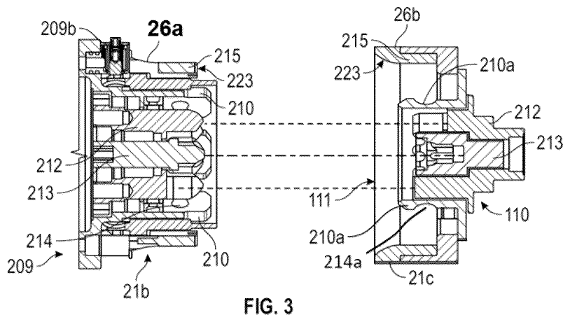

In certain embodiments, referring additionally to FIG. 3, adaptive tooling interface 20 comprises one or more interfaces 215 operatively in communication with controller 250, where each interface 215 may comprise one or more power interfaces 215a which may be an inductive and/or pinless power interface and/or one or more communications interfaces 215b, which may comprise an inductive and/or pinless data communication interface. Power interface 215a and/or communications interface 215b are typically operative to interface with external tools 110 (FIG. 9), sensors, valves, clamps, winches, fixed installations interfaces, other subsea equipment, or the like, or a combination thereof.

In certain embodiments adaptive tooling changer 20 further comprises latch 209 by which external tool 110 (FIG. 9) selected from the predetermined set of external tools 110 is attached to adaptive tooling changer 20, where latch 209 is configured to allow mechanical auto latching latch 209 and may comprise ball lock 214a which may be configured to secure external tool 110 to an external tooling interface or a lock vehicle or lock it into a subsea asset. In embodiments, latch 209 may be disposed at a portion of drive interface 21c (FIG. 2) such as intermediate or as part of external tool interface 21d (FIG. 2) and a portion of second housing section 21b (FIG. 2). Latch 209 may comprise ball lock 214 paired with ball lock receiver 214a, a fin latch, a gripper, a power screw lock, a friction chuck, or the like, or a combination thereof. Typically, ball lock 214a comprises a ball configured to be free to travel into a lock pocket and be secured during engagement without the need for other mechanical or electrical function, e.g., only pure axial force may be all that is needed.

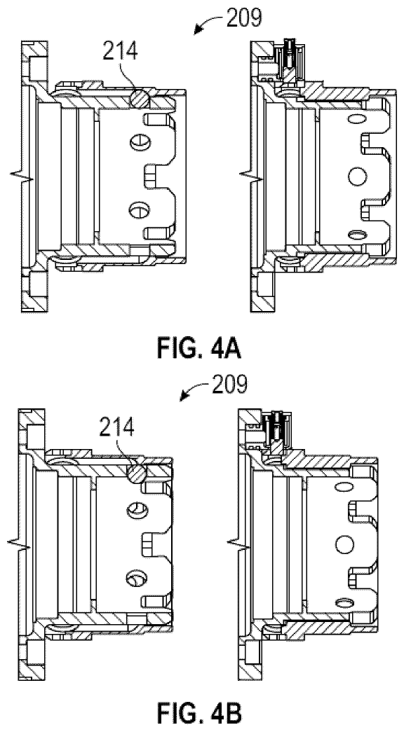

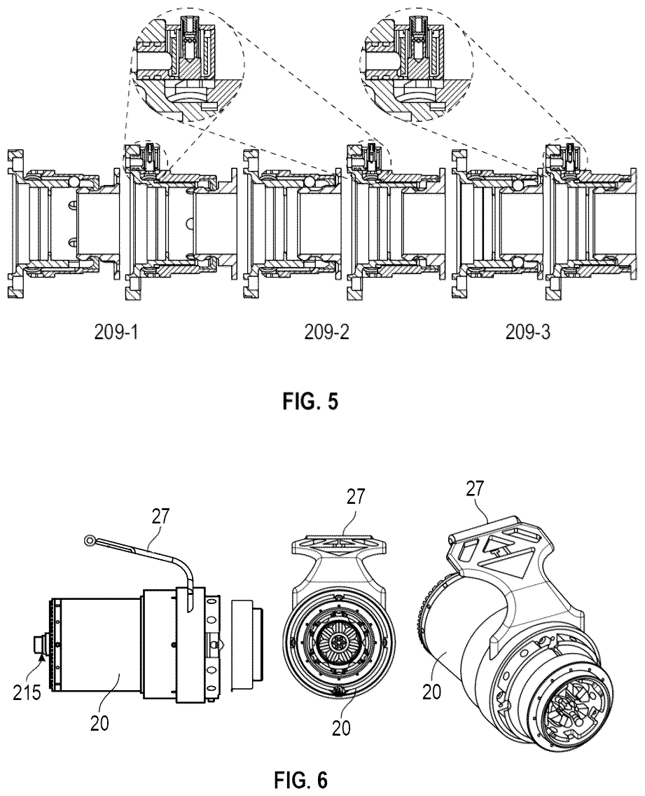

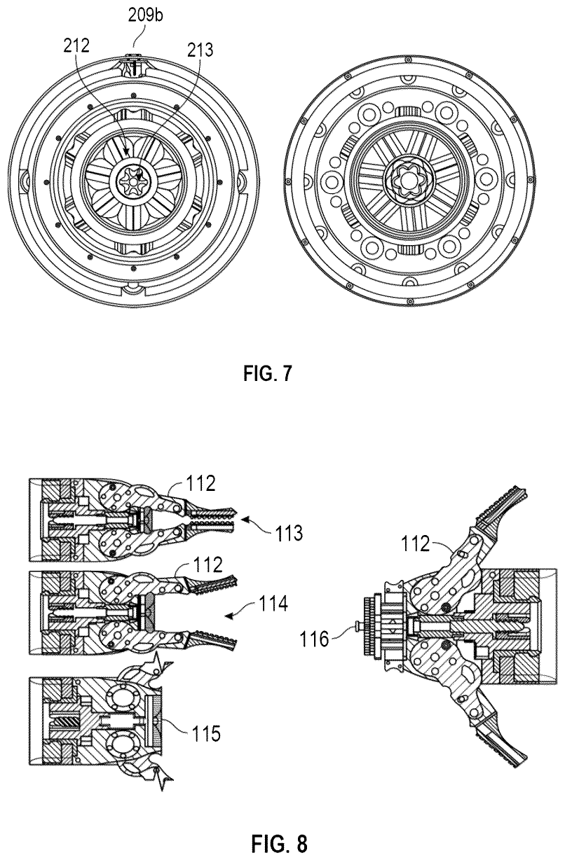

In one embodiment, operation of latch 209 uses ball lock 214 and ball lock receiver 214a. Referring now to FIGS. 4-6, an exemplary operation of ball lock 214 and ball lock receiver 214A are shown, where ball 214 may be in a unlatched mode FIG. 4A or a latched mode FIG. 4B. A progression of latching is illustrated in FIG. 5, where latch 209 is shown in pre-aligned 209-1, engaging 209-2, and locked 209-3 positions.

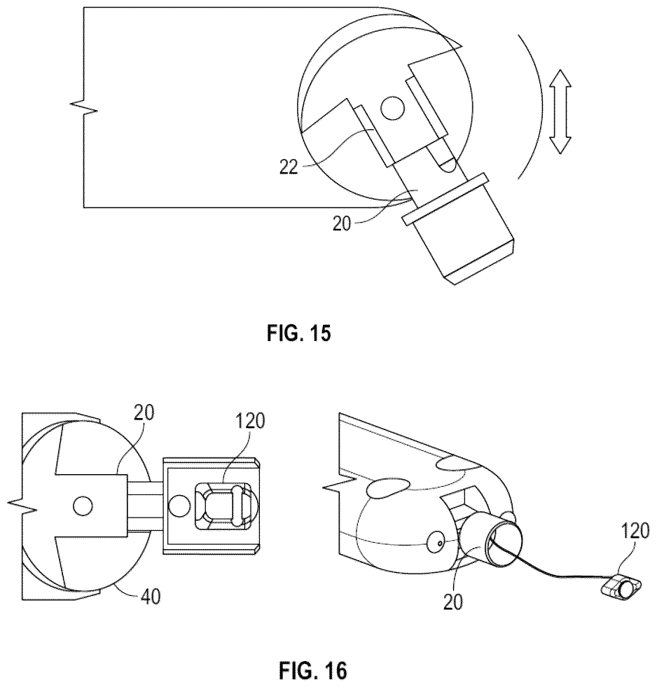

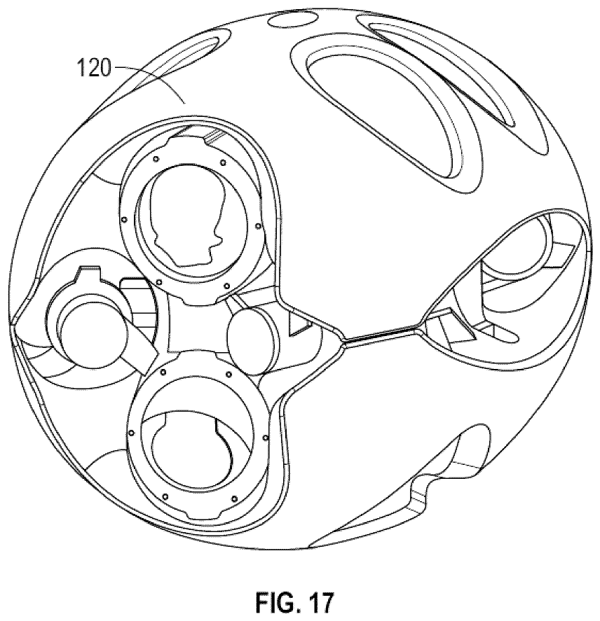

Typically, latch 209 is basic and only requires solenoid 209b to active ball 214 coupled with removing fluid to drive ball sleeve 210 (FIG. 3). To latch a device or vehicle to external tool 110 adaptive external tool interface 20 is typically inserted into external tool 110 (FIG. 9) where it locks external tool 110 using latch 209. In certain embodiments, adaptive external tool interface 20 uses guide 26a when being inserted into guide receiver 26a of external tool 110 to ensure initial alignment, and when inserted into external tool 110 uses one or more fine alignment guides to ensure that ball-lock sleeve 210 is engaged to force ball 214 to engage an interface grove or channel of external tool interface 21c such as at 210a. To hold on to external tool 110 when adaptive external tool interface 20 is withdrawn such as when a subsea device takes external tool 110 with it, solenoid 209b needs to hold ball sleeve 210. In these embodiments, external tool guide 26a pushes ball sleeve 210 which forces ball 214 down in a groove or channel of external tool interface 21c (FIG. 2), e.g. 210a. When fully entered, solenoid 209b, which may be spring loaded, falls down in to a hole in ball sleeve 210, thereby holding ball sleeve 210 back. In these embodiments, latch 209 operates substantially as an auto-lock latch which is all mechanical and solenoid 209b works as a basic spring loaded door lock, only needing power when external tool 110 is docked. To un-dock adaptive tooling interface 20 from external tool 110, a device such as a subsea vehicle or a manipulator holding adaptive tooling interface 20 can axially lock external tool 110 on a further subsea device such as a subsea docking station or a external tool rack such as by a friction lock or J-lock. When external tool 110 is locked, it can subsequently be pushed or compressed to free solenoid 209b piston from ball sleeve 210 such as by using friction, after which power can be applied to solenoid 209b allowing adaptive tooling interface 20 to be pulled off external tool 110. In some embodiments, this will be controlled using software at least partially operative in controller 250 or a subsea vehicle such as miniature tethered inspection remotely operated vehicle 120 (FIG. 16). If miniature tethered inspection remotely operated vehicle 120 needs to be able to dock autonomously, solenoid 209b may be powered before external tool 110 is axially locked. In embodiments comprising miniature tethered inspection ROV 120, it may be selectively resident in a dockable unit which has the same interface as the rest of the AUV external tooling. In these embodiments, miniature tethered inspection ROV 120, after being docked to adaptive external tool interface 20, may be allowed to fly out from subsea vehicle 120 to perform its function.

Referring additionally to FIG. 1Ca Adaptive tooling changer 20 may further comprise compensator 292 which may comprise a self-compensating unit. In certain embodiments, adaptive tooling changer 20 further comprises output shaft 294 configured to move/make a connection to a selected external tool 110 (FIG. 9) regardless of angle and rotation.

In certain embodiments, adaptive tooling changer 20 further comprises a mechanical disconnect and emergency release mechanism.

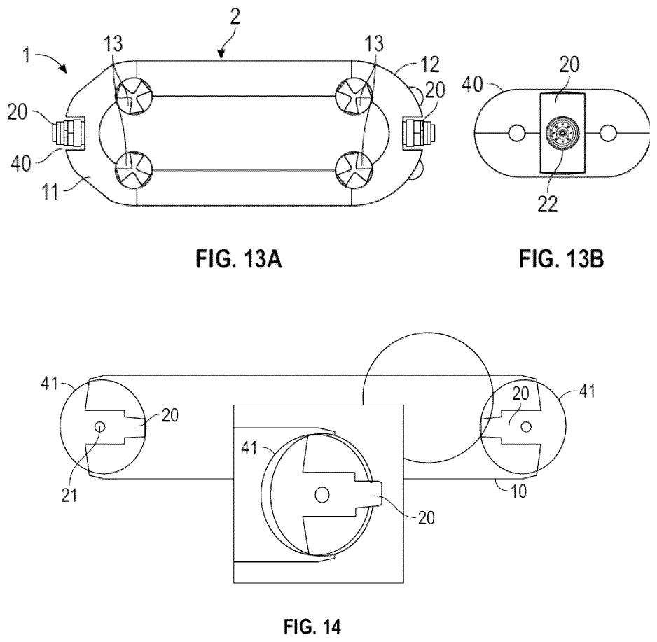

In certain embodiments, adaptive tooling changer 20 further comprises a handle 295, which may be a removable handle, disposed about an outer surface of housing 12 (FIG. 13A) where handle 295 comprises a conventional D-handle interface, a fishtail, or a T-handle, or the like.

In various embodiments, as illustrated in FIG. 1, adaptive tooling interface 20 may comprise GA connector 201, EL 202, one or more water alarms 203 and 208, one or more comp barriers 206, sleeve 210, one or more mechanical seals 211, lip seal 217, one or more springs 218, and one or more magnets 219.

Adaptive tooling interface 20 may further comprise a generation system which is adapted to generate power by converting mechanical power back to electric power. In embodiments, generator/external tool 110 (FIG. 9) is useful to provide power to subsea asset 400 and comprises a predetermined set of external tools 110, at least one external tool 110 comprising a mechanical power interface and an electrical interface; an adaptive tooling changer 20, as described above; and power supply 300 operatively connected to power connector 280. In addition, external tool 110 may comprise one or more of a plurality of external tools 110 such as intervention external tools or manipulator jaws 112 (FIG. 8), where each external tool 110 comprises a matching subsea external tool external tooling interface 111 (FIG. 3). External tool 110 may be freestanding or docked to another device such as a subsea underwater drone. For certain embodiments, drive interface 21c (FIG. 2) comprises an external tooling interface for drone subsea external tooling needs

By way of example and not limitation, adaptive tooling interface 20 may use one or more of its motors 220,221 as generators to power or otherwise charge a subsea vehicle 2 (FIG. 13A) or equipment attached to adaptive tooling interface 20. By way of further example and not limitation, adaptive tooling interface 20 can drive an external motor to generate electrical power and provide that power such as over a tether to subsea vehicle 2, charging stationary equipment, or the like, or a combination thereof. By way of still further example and not limitation, adaptive tooling interface 20 can power a hydraulic or water-based pump for fluid operated functions and use communications interface 215 to aid in effecting control of built in valves and/or read sensor data.

Again referring to FIG. 1C, external power source 310 may also be present and operatively connected to power connector 280 and may comprise a remotely operated vehicle power source, an autonomously operated vehicle power source, or a subsea asset power source.

Where external power source 310 comprises or is otherwise a part of subsea asset 400 (FIG. 9), adaptive tooling changer 20 may be configured to be removably connected to subsea asset 400 and configured to receive power or data communications from subsea asset 400.

In certain embodiments, generator/external tool 100 further comprises a wet mate connector adapted to allow supplying of electrical power to the subsea asset.

Generator/external tool 100 may further comprise internal power source 281 operatively connected to power connector 280, e.g., a battery or a fuel cell.

The external tool changer interface may further comprise a geared interface and the predetermined set of external tools 110 comprise external tools 110 comprising a complimentary gearing interface adapted to interface with external tool changer geared interface. In other embodiments, the external tool changer interface comprises a direct drive interface and the predetermined set of external tools 110 comprises external tools 110 comprising a complimentary direct drive interface adapted to interface with external tool changer direct drive interface.

Generator/external tool 110 may further comprise a radio frequency identifier (RFID) 223 (FIG. 3) and an RFID receiver. In addition, adaptive external tool interface 20 may comprise guide 26a (FIG. 3), such as a portion of second housing section 21b (FIG. 2), which can help align and drive interface 21c or dock external tool interface 21d (FIG. 2) with external tool 110 at guide receiver 26b (FIG. 3). One or more identifiers, such as RFID 223, may be present to help allow controller 250 to know which external tool 110 has been interfaced with external tool interface 21d.

Referring additionally to FIG. 2, the power provided by external tool interface 21d may comprise rotational power, hydraulic power, electrical power, or the like, or a combination thereof. Single motor 220 (FIG. 1) may be adapted to allow driving both a torque external tool latch function and the main rotational mechanism during operation of a rotational valve, all thru one interface such as external tool interface 21d. The rotational ability of adaptive tooling interface 20 can also give specific external tooling added function, as an example, a simple grip/jaw external tool mounted in or on adaptive tooling interface 20 can be rotated to a vertical position to pick up debris on the seabed, without pitching subsea vehicle 2 (FIG. 13A) to which adaptive tooling interface 20 is mounted or integrated.

Referring now to FIG. 6, in certain embodiments manipulator interface 27 may be connected to or otherwise integrated with adaptive tooling interface 20.

In certain embodiments, referring additionally to FIG. 8, adaptive tooling interface 20 (FIG. 1) may further comprise manipulator jaw 112 operatively connected to drive interface 21c (FIG. 2). Manipulator jaw 112 may further comprise brush external tool 116, soft line cutter 115, cathodic protection probe 113, pipe grabber 114, or the like, or a combination thereof.

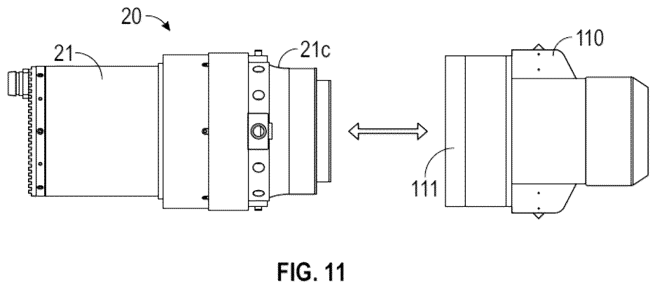

FIG. 10 illustrates external tool 110 connected to adaptive tooling interface 20 and FIG. 11 illustrates external tool disconnected from adaptive tooling interface 20.

In embodiments, referring to FIG. 12, controller 250 comprises one or more network interfaces 251 and one or more output data network pathways 252,253 operatively in communication with control circuitry 254. At least one network interface 251 is typically in communication with control circuitry 254 operatively in communication with the network interface. Controller 250 may be used to monitor mechanical and electrical output parameters such as RPM, position, torque, voltage, amperage, power consumption, water intrusion, and the like, or a combination thereof.

In such embodiments, control circuitry 254 may additionally be operatively in communication with power interface 215a. Further, if one or more communications interfaces 215b are present, control circuitry 254 may additionally be operatively in communication communications interface 215b.

In embodiments adaptive tooling interface 20 further comprises one or more balancing weights which may comprise a selectively detachable clump weight comprising a predetermined size and density.

Referring now to FIG. 13A, subsea vehicle system 1 comprises subsea vehicle 2 and first adaptive external tool interface 20 rotatably disposed at least partially within vehicle housing 10 proximate the first end 11 where first adaptive external tool interface 20 is as described above. First adaptive external tool interface 20 can be mounted statically on subsea vehicle 2, integrated into subsea vehicle 2, or mounted to an actuator or conventional ROV manipulator with one or more axes of movement.

Subsea vehicle 2, which may be a remotely operated vehicle(ROV) , an autonomous underwater vehicle (AUV), a subsea drone, a dredging vehicle, a subsea crawler, a hybrid underwater vehicle, a resident remotely operated vehicle, a skid, or the like, whether tethered or untethered, comprises vehicle housing 10, which comprises a first end 11 and a second end 12, first external tool interface 40 at least partially disposed within vehicle housing 10, and a first void defined to open to an external environment at first end 11 of vehicle housing 10. Subsea vehicle 2 is typically adapted for operating external tooling to perform subsea intervention and may have one or more propulsion systems 13 to allow maneuvering subsea. Subsea vehicle 2 is further configured to be close to neutral in water with a pivot point disposed proximate a center of subsea vehicle 2 for optimal maneuverability, whereby external tool 110 load in a far end 11 will have a large impact.

As illustrated in FIG. 13B, adaptive external tool interface 20 is typically rotatably concealed in a first position and configured to be selectively commanded to rotate 180 degrees to align the interface for operation such as by exposing external tool interface 21d (FIG. 2) to an external environment, e.g. a subsea environment, via the first void defined by first external tool interface 40 via rotator 22 FIG. 13B. In certain embodiments, first hydrodynamic shaped cover 41 is selectively positionable over first external tool interface 40 such as via its own rotation mechanism or rotator 22. First hydrodynamic shaped cover 41 may be positioned during in flight mode to conceal adaptive external tool interface 20 and, on command, rotate to allow adaptive external tool interface 20 to be aligned for operation such as by rotation which may be concurrent or independent of the rotation of first hydrodynamic shaped cover 41. The “in flight” orientation of adaptive external tool interface 20 coupled with the rotation of first hydrodynamic shaped cover 41 can reduce drag.

Additionally, subsea vehicle 2 may comprise a motor configured to allow rotation of adaptive tooling interface 20 and to provide pitch degree of freedom to external tool 110.

In certain embodiments, as partially described above, first adaptive external tool interface 20 further comprises an integrated balancing system adapted to make first adaptive external tool interface 20 self-balancing and sufficient to provide for supporting first adaptive external tool interface 20 for an added external tool load in end 11 or 12 of vehicle housing 10 without the need for additional thruster support and increased power usage. This integrated balancing system typically further comprises one or more balancing weights as described above and control system 30 operative to allow a subsea vehicle to detach the clump weight when docking onto external tool 110 to leave the center of gravity/pivot point unchanged.

In embodiments, first adaptive external tool interface 20 further comprises a failsafe mechanism configured to allow subsea vehicle system 1 to disconnect and reconnect with external tool 110 when external tool 110 is operatively connected to adaptive external tool interface 20 such as in the event of a external tool or subsea vehicle failure. The failsafe mechanism may comprise latch 209, as described above, which may be spring loaded in an unlocked position and hydraulically energized into a locked position such that upon loss of power or hydraulic failure, latch 209 will fail to an unlatched position.

In most embodiments, external tool 110 comprises a matching subsea external tool external tool interface 111 which is adapted to interface with external tool 110 such as an intervention external tool or manipulator jaw 112 (FIG. 8) which may be docked onto miniature tethered inspection remotely operated vehicle 120 (FIG. 16) or other device such as a subsea drone.

In certain embodiments, subsea vehicle 2 further comprises one or more additional external tool interfaces 40, such as second external tool interface 40, at least partially disposed within vehicle housing 10 where the second external tool interface 40 defines a second void open to the external environment at second end 12 of vehicle housing 10, and a corresponding additional adaptive external tool interface such as second adaptive external tool interface 20 which is substantially identical to first adaptive external tool interface 20 and which is rotatably disposed at least partially within vehicle housing 10, such as proximate to second end 12 of vehicle housing 10.

In contemplated embodiments, as noted above adaptive external tool interface 20 can be fixed to or otherwise integrated with subsea asset 400 or be configured as a standalone unit. By way of example and not limitation, this may include being fixed to a valve or used as a motor unit on a docking station tether management system (TMS). By way of further example and not limitation, adaptive external tool interface 20 can be used to house a TMS and power the TMS′ tether in and out for subsea vehicle system 1 to operate remotely as well as autonomously. In other contemplated embodiments, a TMS is configured as a standalone external tool which can turn the mechanical power from adaptive external tool interface 20 into spooling/hold-back functions while communications interface 215b from adaptive external tool interface 20 provides data communications, thus allowing for a redundant TMS external tool which is completely separated from adaptive external tool interface 20.

In the operation of exemplary methods, referring generally back to FIG. 1, selecting and using external tool 110 (FIG. 9) may occur subsea using adaptive tooling changer 20, as described above, by positioning a predetermined set of external tools 110 proximate subsea asset 400; positioning adaptive tool changer 20 proximate the predetermined set of external tools 110; maneuvering adaptive tool changer 20 to the predetermined set of external tools 110; selecting a desired external tool 110 from the predetermined set of external tools 110; physically connecting the desired external tool 110 to the external tool changer interface; and operatively interconnecting the mechanical power interface of selected external tool 110 to first power output 213 and the electrical interface of selected external tool 100 to second power output 212. Motor 220 may be energized using a power source operatively connected to motor 220, e.g., power supply 300 or external power source 310; supplying the selected external tool 110 with mechanical power via first power output 213; and supplying the selected external tool 110 with electrical power and/or data via second power output 212. When desired, the selected external tool's mechanical power interface may be disconnected from first power output 213 and the selected external tool's electrical interface disconnected from the second power output 212.

Interfacing the selected external tool's electrical interface to second power output 212 may be via induction.

Where the selected external tool 110 comprises a radio frequency identifier (RFID) sender/tag and adaptive tooling changer 20 further comprises an RFID receiver, the RFID sender/tag may be used to provide adaptive tooling changer 20 with the external tool identifier of selected external tool 100 and the received identifier of external tool's external tool 110 used for a further operation such as positive external tool identification, serial number, or calibration optimization, or the like, or a combination thereof.

A multi-radial direction external tooling docking system, comprising an external tooling connector operatively connected to adaptive tool changer 20 and comprising a plurality of docking angles, may be present and the external tooling connector used to adjust and resolve angular resolution to allow angular displacement of a predetermined set of docking positions between adaptive tool changer 20 and a subsea asset. Adjusting and resolving may be radial.

Adaptive tooling changer 20 may further comprise a mechanical disconnect and emergency release mechanism and be disposed proximate to or in an external carrier where the mechanical disconnect and emergency release mechanism may be used to release adaptive tool changer 20 from the external carrier which may be a external tool, a cage, a subsea asset, or a semi resident external tool changer mounted to a subsea asset, or the like.

Subsea vehicle 2 (e.g., ROV/AUV 120 (FIG. 16)) may be operatively connected to and provide power to adaptive tooling changer 20. If that subsea vehicle 2 is dead and cannot provide power to adaptive tooling changer 20, and the mechanical disconnect and emergency release mechanism comprises a wedge release, a main cable connection between the subsea vehicle and adaptive tooling changer 20 may be used to pull on the wedge release to physically disconnect adaptive tooling changer 20.

Where a generator is present, the generator may be operatively connected to adaptive tool changer 20 and used to provide power to subsea asset 400. Adaptive tooling changer 20 may be used to drive generator external tool 110, provide mechanical power to the selected external tool 110, or both.

The foregoing disclosure and description of the inventions are illustrative and explanatory. Various changes in the size, shape, and materials, as well as in the details of the illustrative construction and/or an illustrative method may be made without departing from the spirit of the invention.

1) A method of selecting and using an external tool subsea, the external tool selected from a predetermined set of external tools, where at least one external tool comprises a mechanical power interface and an electrical interface, using an adaptive tooling changer, comprising a housing, a single motor disposed at least partially in the housing, a power connector operatively in communication with the single motor, a switch operatively connected to the single motor, a external tool changer interface comprising a first power output operatively in communication with the switch and operative to provide power to an external tool selected from a predetermined set of external tools and a second power output operatively in communication with the switch and operative to provide power to the selected external tool, and a power supply operatively connected to power connector, the method comprising:
a) positioning a predetermined set of external tools proximate a subsea asset;
b) positioning the adaptive tool changer proximate the predetermined set of external tools;
c) maneuvering the adaptive tool changer to the predetermined set of external tools;
d) selecting a desired external tool from the predetermined set of external tools;
e) physically connecting the desired external tool to the external tool changer interface; and
f) operatively interconnecting the selected external tool's mechanical power interface to the first power output and the selected external tool's electrical interface to the second power output.

2) The method of selecting and using an external tool subsea of claim 1, further comprising:
a) energizing the motor using a power source operatively connected to the motor;
b) supplying the selected external tool with mechanical power via the first power output; and
c) supplying the selected external tool with electrical power and/or data via the second power output.

3) The method of selecting and using an external tool subsea of claim 2, wherein the selected external tool's electrical interface to the second power output is via induction.

4) The method of selecting and using an external tool subsea of claim 2, further comprising a multi-radial direction external tooling docking system, comprising an external tooling connector operatively connected to the adaptive tool changer, the external tooling connector comprising a plurality of docking angles, the method further comprising using the external tooling connector to adjust and resolve angular resolution to allow angular displacement of a predetermined set of docking positions between the adaptive tool changer and a subsea asset.
